(19) United States
(12) Patent Application Publication
(10) Pub. No.: US 2015/0069036 A1
(43) Pub. Date: Mar. 12, 2015

(54) LIGHT SYSTEM FOR ENGINE DRIVEN WELDER

(71) Applicant: LINCOLN GLOBAL, INC., City of Industry, CA (US)

(72) Inventor: SAMIR F. FARAH, BROADVIEW HEIGHTS, OH (US)

(73) Assignee: LINCOLN GLOBAL, INC., City of Industry, CA (US)

(21) Appl. No.: 14/091,573

(22) Filed: Nov. 27, 2013

Related U.S. Application Data
(60) Provisional application No. 61/876,791, filed on Sep. 12, 2013.

(51) Int. Cl. B23K 9/10

(52) U.S. Cl. CPC B23K 9/1006
USPC 219/134

(57) ABSTRACT

The invention described herein generally pertains to a system and method for including an illumination system with an engine driven welding device. In particular, an engine driven welding device can include a power source such as a motor and/or an energy storage device that can be utilized to power an illumination system that provides lighting and/or illumination to an environment via at least one lighting element.

### CROSS-REFERENCE TO RELATED APPLICATIONS

This application claims the benefit of priority to U.S. Provisional Application Ser. No. 61/876,791, filed Sep. 12, 2013, and entitled “LIGHT SYSTEM FOR ENGINE DRIVEN WELDER.” The entirety of the aforementioned application is incorporated herein by reference.

### TECHNICAL FIELD

The invention described herein pertains generally to a system and method that incorporates an illumination system with an engine driven welder, and in particular, a lighting element that uses power from the engine driven welder to provide illumination of an environment.

### BACKGROUND OF THE INVENTION

Frequently, welding is required where supply power may not be readily available. As such, the welding power supply may be an engine driven welding power supply incorporating a generator. The generator may supply power to the welder as well as to other power tools as may be needed on site. As different applications require different versions of welders and power tools, the trailer may be designed to carry one of many different types of welding power supplies.

Traditional welding-type apparatus can be broken into two basic categories. The first category receives operational power from transmission power receptacles, also known as static power. The second is portable or self-sufficient, stand alone welders having internal combustion engines, also known as rotating power. While in many settings conventional static power driven welders are preferred, engine driven welders enable welding-type processes where static power is not available. Rotating power driven welders operate by utilizing power generated from engine operation. As such, engine driven welders and welding-type apparatus allow portability and thus fill an important need.

Static powered welders initiate the weld process by way of a trigger on a hand-held torch or with an electrically charged stick connected to a charged electrode.

Rotating power driven welders operate similarly, as long as the engine is running. If the engine is shut down, there is typically no residual power to create an arc. To once again weld, the engine must be started and run at operational speed to produce the arc. Therefore, it is simply not possible to manually start and stop the engine between each and every break in the welding process. Further, even during longer periods, operators may find it easier to let the engine run because of distance to the engine, a misconception that it is better for the engine, or just out of habit.

### SUMMARY OF THE INVENTION

In accordance with the present invention, there is provided a welding device that includes a motor-driven welder assembly including a motor that is a power source for the welder device to perform a welding operation and a circuit component that electrically isolates and converts the power source to a first voltage used for controlling the welding operation. The welding device can further include a converter component that converts the first voltage to a second voltage. The welding device can further include a lighting element that uses a portion of the second voltage as a light power source to illuminate the lighting element, wherein the lighting element illuminates based on a switch.

In accordance with the present invention, there is provided a method that includes at least the following steps: utilizing at least one of a motor or an energy storage device to supply a voltage for use with a welding operation; receiving the voltage; reducing the voltage to an isolated second voltage, wherein the isolated second voltage is less than the voltage from the motor; and utilizing the isolated second voltage to power a lighting element.

In accordance with the present invention, there is provided a welding device that includes at least the following: a motor-driven welder assembly including a motor that is a power source for the welder device to perform a welding operation; a circuit component that electrically isolates and converts the power source to a first voltage used for controlling the welding operation; a converter component that converts the first voltage to a second voltage; a housing for containing the lighting element; an energy storage device affixed to the housing, wherein the energy storage device stores a portion of the second voltage; a support member coupled to the housing, wherein the support member is detachable from a housing of the welding device; and means for emitting light using the portion of the second voltage as a primary power source.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a block diagram illustrating a welding device that includes a motor as a power source;

FIG. 2 is a block diagram illustrating a welding device;

FIG. 3 is a block diagram illustrating a welding device affixed to a trailer for mobility;

FIG. 4A is a block diagram illustrating a welding device;

FIG. 4B is a block diagram illustrating a welding device;

FIG. 5 is a block diagram illustrating a welding device that includes an illumination system;

FIG. 6 is a block diagram illustrating a welding device that converts voltage generated by a power source of the welding device for use with an illumination system;

FIG. 7 is a block diagram illustrating a welding device that includes an extendable lighting element to illuminate an environment; and

FIG. 8 is a flow diagram of converting a voltage from a power source associated with an engine driven welder for use a lighting element.

### DETAILED DESCRIPTION OF THE INVENTION

Embodiments of the invention relate to methods and systems that generally relate to converting a voltage generated by a power source of a welding device to a second voltage, wherein the second voltage is lower than the first voltage and is used to power a lighting element. For instance, a first circuit component can convert a voltage from the power source of the welding device, wherein the voltage is used for control of a welding operation. An illumination system can receive a portion of the voltage or convert a portion of the voltage for use as a light power source to power a lighting element to provide illumination to an environment. For example, a motor of a welding device can generate a voltage and such voltage can be converted for control of a welding operation. Additionally, a converter component can be configured to convert and isolate the voltage to a second voltage that is used as a light power source for the lighting element. In another embodiment, the lighting element can include an energy storage device that stores a portion of the second voltage.

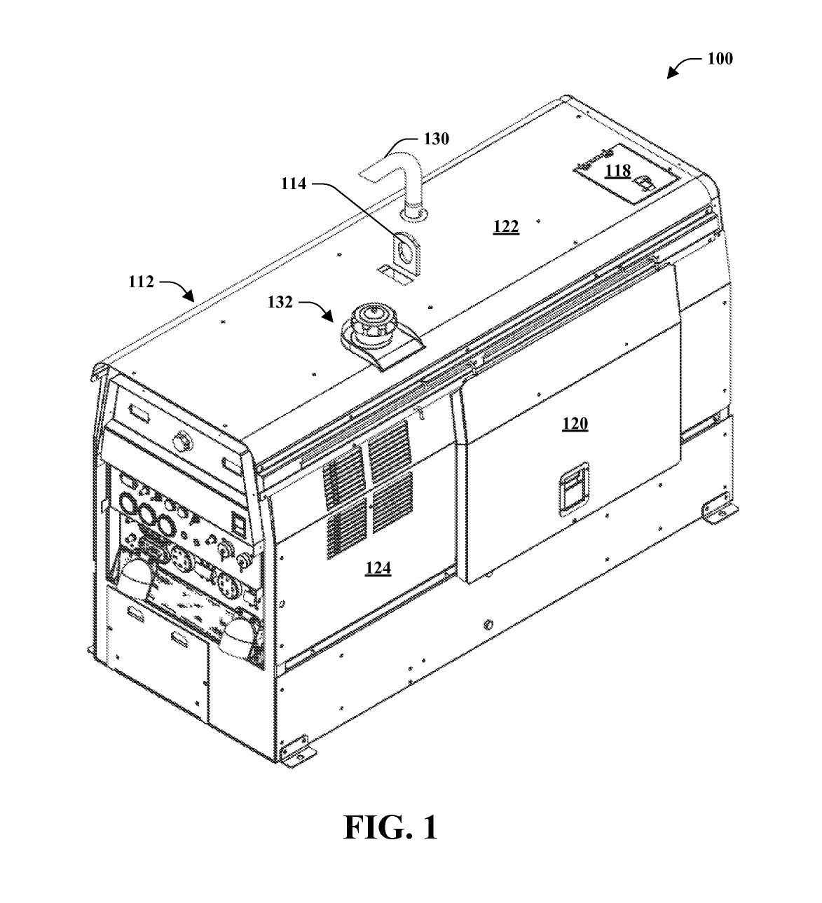

The subject innovation can be used with any suitable engine-driven welder, engine-driven welding system, engine-driven welding apparatus, a welding system powered by an engine, a welding system powered by a battery, a welding system powered by an energy storage device, a hybrid welder (e.g., a welding device that includes an engine driven power source and an energy storage device or batter), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a component that converts electrical power, or a combination thereof. By way of example and not limitation, FIGS. 1-4 illustrate welding systems or devices that can be utilized with the subject innovation. It is to be appreciated that the following welding systems are described for exemplary purposes only and are not limiting on the welding systems that can utilize the subject innovation or variations thereof.

FIG. 1 illustrates a welding device 100. The welding device 100 includes a housing 112 which encloses the internal components of the welding device. Optionally, the welding type device 100 includes a loading eyehook 114 and/or fork recesses. The loading eyehook 114 and the fork recesses facilitate the portability of the welding device 100. Optionally, the welding-type device 100 could include a handle and/or wheels as a means of device mobility. The housing 112 also includes a plurality of access panels 118, 120. Access panel 118 provides access to a top panel 122 of housing 112 while access panel 120 provides access to a side panel 124 of housing 112. A similar access panel is available on an opposite side. These access panels 118, 120, provide access to the internal components of the welding device 100 including, for example, an energy storage device (not shown) suitable for providing welding-type power. An end panel includes a louvered opening to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or side panel 124. Such a construction protects the fuel port 132 from damage during transportation and operation of the welding-type device 100.

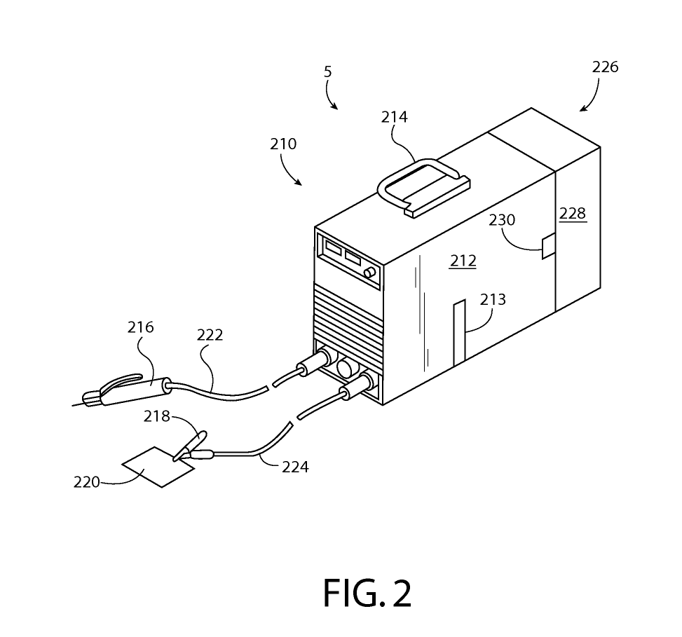

Referring now to FIG. 2, a perspective view of a welding apparatus 205 that can be utilized with the subject innovation. Welding apparatus 205 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding device 210 thereby forming welding-type apparatus 205. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

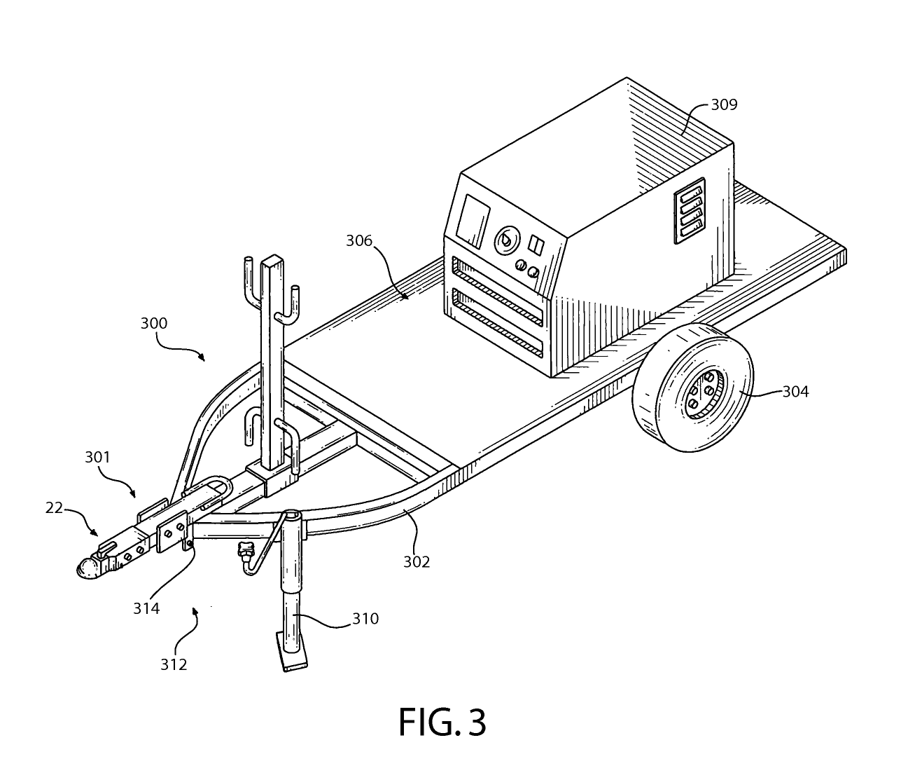

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 309 or an engine driven welding power supply 309. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

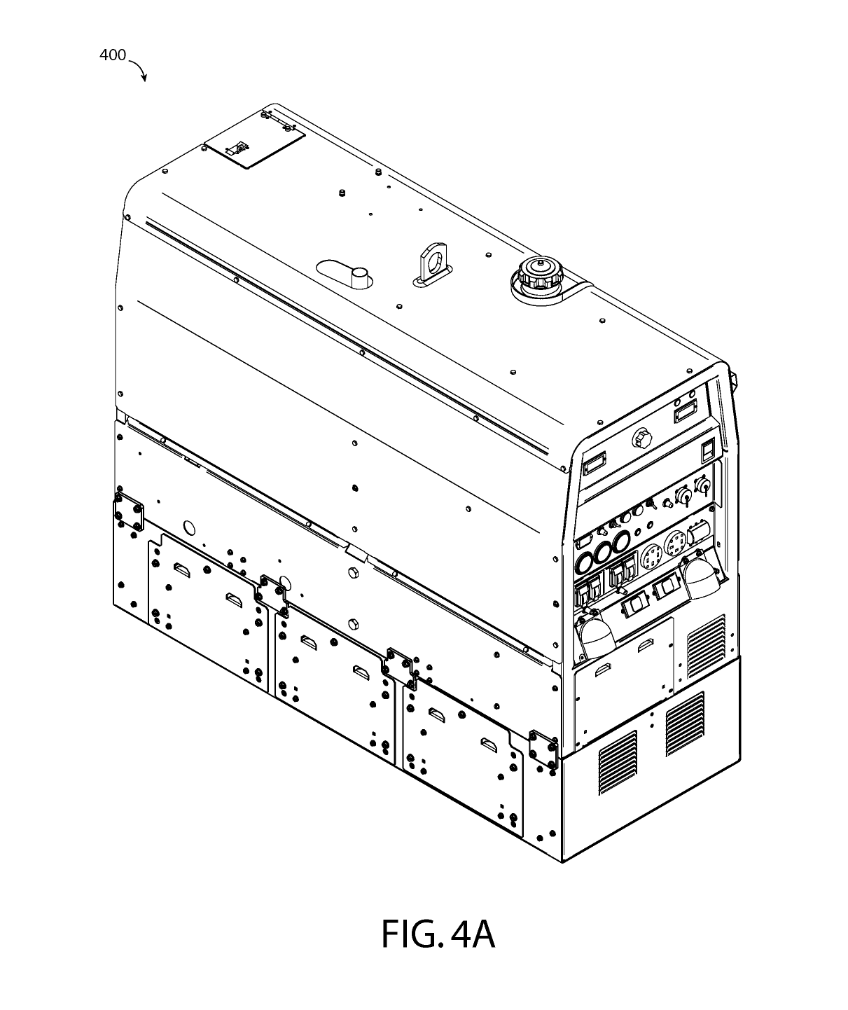

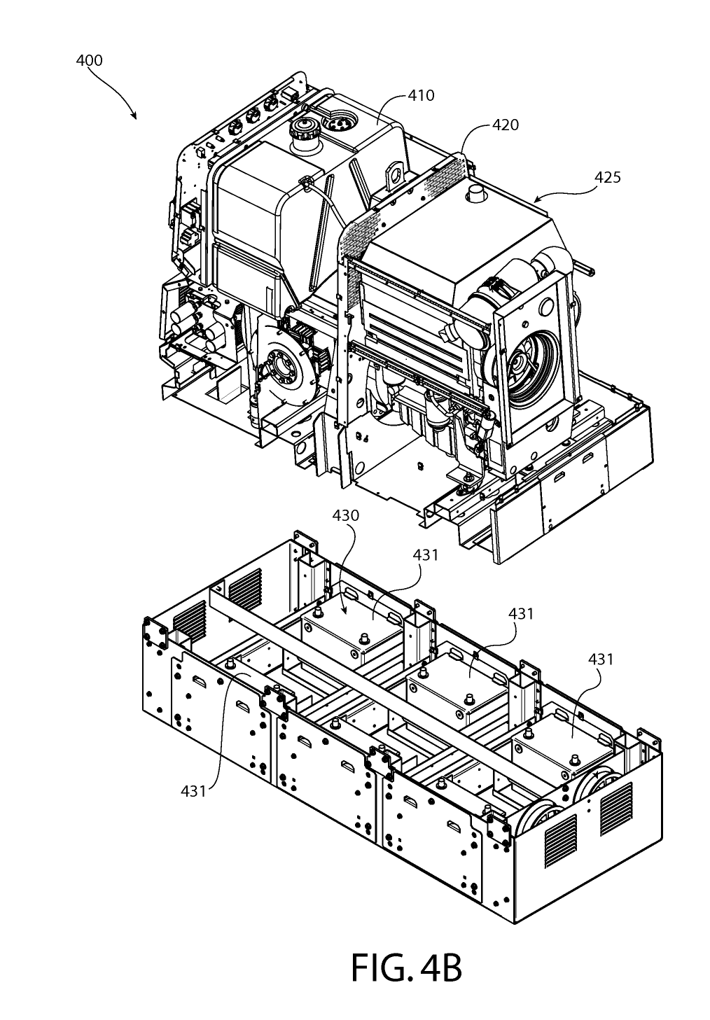

FIGS. 4A and 48 illustrate a hybrid welding device (herein referred to as a “hybrid welder”). A hybrid welder according to the invention is generally indicated by the number 400 in the drawings. Hybrid welder 400 includes an engine component that runs on fuel from fuel storage 410 allowing the hybrid welder 400 to be portable. It will be appreciated that hybrid welder 400 may also be mounted in a permanent location depending on the application. Hybrid welder 400 generally includes a motor-driven welder assembly 420 having a motor 425 and an energy storage device 430. Motor 425 may be an internal combustion engine operating on any known fuel including but not limited to gasoline, diesel, ethanol, natural gas, hydrogen, and the like. These examples are not limiting as other motors or fuels may be used.

The motor 425 and energy storage device 430 may be operated individually or in tandem to provide electricity for the welding operation and any auxiliary operations performed by hybrid welder 400. For example, individual operation may include operating the motor 425 and supplementing the power from the motor 425 with power from the energy storage device 430 on an as needed basis. Or supplying power from the energy storage device 430 alone when the motor 425 is offline. Tandem operation may also include combining power from motor 425 and energy storage device 430 to obtain a desired power output. According to one aspect of the invention, a welder 400 may be provided with a motor having less power output than ordinarily needed, and energy storage device 430 used to supplement the power output to raise it to the desired power output level. In an embodiment, a motor with no more than 19 kW (25 hp) output may be selected and supplemented with six 12 volt batteries. Other combinations of motor output may be used and supplemented with more or less power from energy storage device. The above example, therefore, is not limiting.

Energy storage device 430 may be any alternative power source including a secondary generator, kinetic energy recovery system, or, as shown, one or more batteries 431. In an embodiment, six 12 volt batteries 431 are wired in series to provide power in connection with motor-driven welder assembly 420. Batteries 431 shown are lead acid batteries. Other types of batteries may be used including but not limited to NiCd, molten salt, NiZn, NiMH, Li-ion, gel, dry cell, absorbed glass mat, and the like.

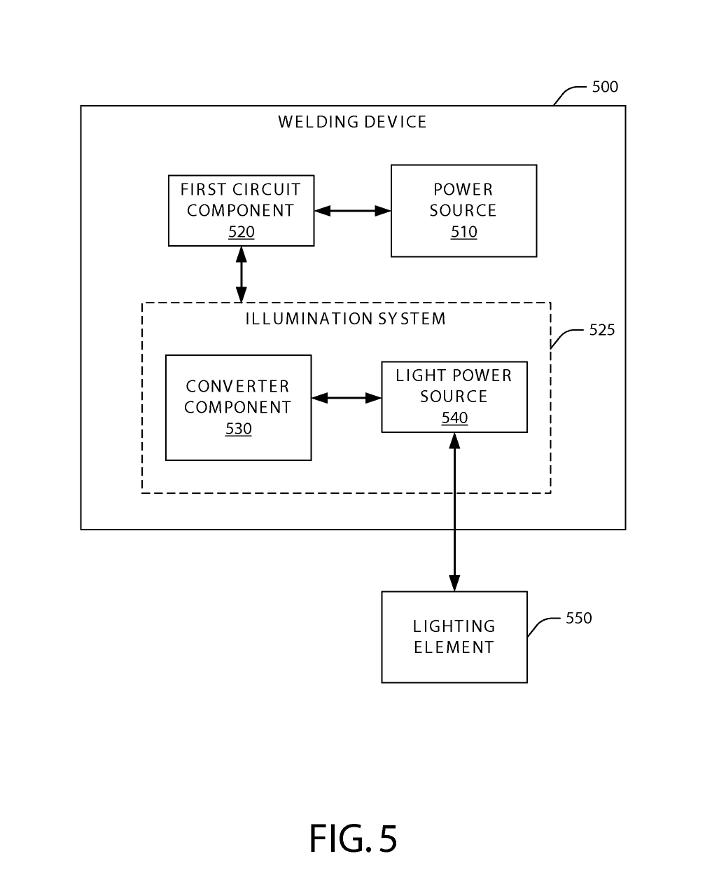

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 5-7 illustrate a schematic block diagram of a welding device, and in particular, an engine driven welding device as discussed in FIGS. 1-4.

Turning to FIG. 5, welding device 500 is illustrated that includes power source 510 that generates voltage for use with performing a welding operation. By way of example and not limitation, power source 510 can be a motor, an engine, an energy storage device, an outlet (e.g., AC/DC outlet source for voltage) configured to receive a power supply, a combination thereof, among others. It is to be appreciated that power supply 510 can be chosen with sound engineering judgment without departing from the intended scope of coverage of the embodiments of the subject invention. For instance, a power source used with an engine driven welding device can be utilized as power source 510. Power source 510 as used in the subject innovation can generate and/or convert a plurality of voltages such simultaneously or at different times. For instance, a first voltage can be generated and a second voltage can be converted from the first voltage, wherein the conversion can be after the generation of the first voltage. In another embodiment, the second voltage can be converted at the same time as the generation of the first voltage. In still another embodiment, power source 510 can generate the first voltage and the second voltage at the same time such that no conversion is provided since the first voltage and the second voltage are generated directly. It is to be appreciated that these variations of voltage generation and conversion can be provided by power source 510 as well as other power sources described herein with the subject innovation.

Welding device 500 further includes first circuit component 520 that is configured to isolate and convert the voltage generated by power source 510 for use with a welding operation. For example, first circuit component 520 can include any suitable circuitry that converts power source 510 for use with a welding operation. For instance, first circuit component 520 can convert a first voltage from power source 510 to a control voltage that is used for controlling a welding operation, wherein the first voltage is greater than the control voltage. By way of example and not limitation, first circuit component 520 can be an isolation stepdown circuit. Moreover, it is to be appreciated that first circuit component 520 can be chosen with sound engineering judgment without departing from the intended scope of coverage of the embodiments of the subject invention. For example, although welding device 500 is illustrated with first circuit component 520, any suitable number of circuits can be utilized by the subject innovation.

First circuit component 520 can be configured to isolate and convert the voltage from power source 510. First circuit component 520 can further condition voltages from power source 510 so as to reduce effects from power source 510. By way of example and not limitation, conditioning can relate to a filtering of a signal, a noise reduction of a signal, isolation of a signal, and the like. For instance, a conditioning of a signal can be performed by, but not limited to, an optical coupler, a transformer, among others. It is to be appreciated and understood that first circuit component 520 can be a stand-alone component (as depicted), incorporated into converter component 530, incorporated into illumination system 525, or a combination thereof

Illumination system 525 can include a converter component 530 that can receive a portion of the first voltage and convert such first voltage into a second voltage, wherein the second voltage is utilized by illumination system 525. It is to be appreciated and understood that converter component 530 can be a stand-alone component (as depicted), incorporated into first circuit component 520, or a combination thereof. Illumination system 525 utilizes the second voltage as light power source 540 to provide lighting or illumination to an environment (discussed in more detail below). Converter component 530 can provide a conversion of a portion of the first voltage and at least one of an isolation of the second voltage or a conditioning of the second voltage. By way of example and not limitation, conditioning can relate to a filtering of a signal, a noise reduction of a signal, isolation of a signal, and the like. For instance, a conditioning of a signal can be performed by, but not limited to, an optical coupler, a transformer, among others. By way of example, converter component 530 can be an isolation stepdown circuit.

Lighting element 550 is powered by light power source 540 that has voltage provided by the second voltage as discussed above. By way of example and not limitation, lighting element 550 can be a bulb, a filament bulb, a Light Emitting Diode (LED), a fluorescent, a halogen, a Compact Fluorescent Lamp (CFL), among others. Lighting element 550 can be integrated into welding device 500, detachable from welding device 500, attached to welding device 500, a combination thereof, and the like. For instance, lighting element 550 can provide illumination to an environment based on being a portable and detachable. This portability allows lighting element 550 to reach areas that welding device 500 cannot. In another embodiment, a portable stand is stored with welding device 500 such that the portable stand can allow lighting element 550 to be positioned in an environment. In still another embodiment, lighting element 550 can be incorporated into an area of a housing of welding device. For instance, lighting element 550 can be affixed to a front of welding device 500, a rear of welding device 500, a side of welding device 500, or a combination thereof. In still another embodiment, lighting element 550 can be adjustable for user-specified aiming of a light or an illumination of an environment.

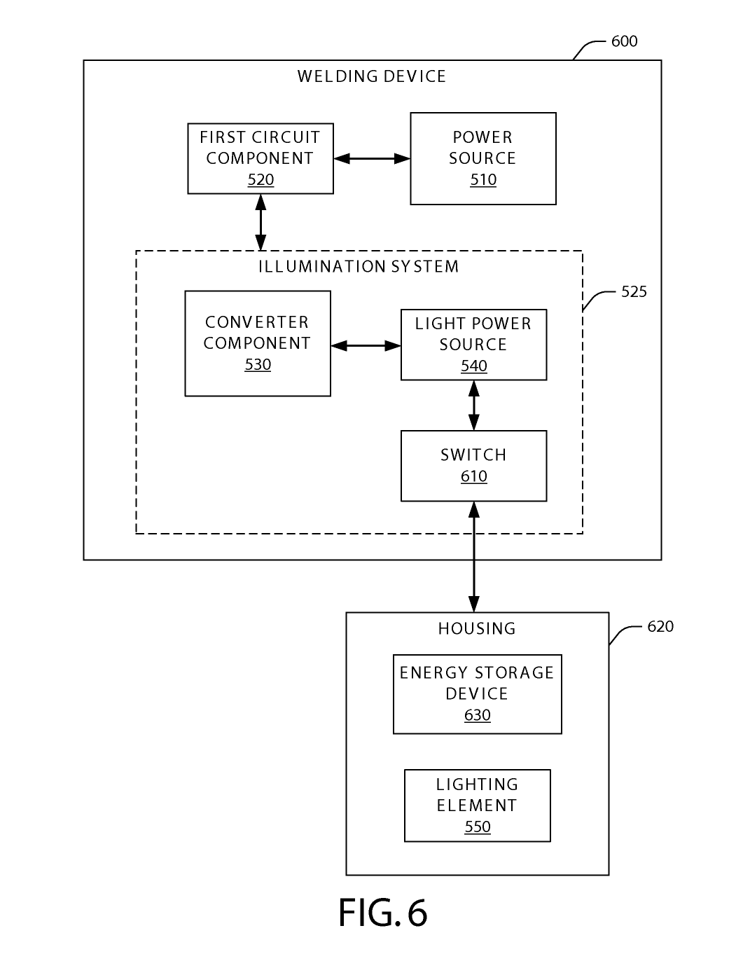

FIG. 6 illustrates welding device 600 that converts a voltage from power source 510 of the welding device to a second voltage for use with illumination system 525. In an embodiment, power source 510 can include a hybrid power source that includes motor component (not shown) and energy storage device (not shown). It is to be appreciated that the hybrid power source can be substantially similar to the hybrid device discussed above in FIGS. 4A and 48. For instance, motor component can generate a voltage and such voltage can be stored in energy storage device. Switch component (not shown) can automatically select between motor component and energy storage device for a power source for the welding operation performed by the welding device 600. In an embodiment, the switch component can select between motor component and energy storage device based upon a welding parameter. For instance, the welding parameter can be, but is not limited to, a voltage of the welding operation, a current of the welding operation, a welding schedule parameter (e.g., welding process, wire type, wire size, wire feed speed (WFS), volts, trim, wire feeder to use, feed head to use, among others), a position of a welding tool, a composition of the workpiece on which the welding operation is performed, a position or location of an operator, sensor data (e.g., video camera, image capture, thermal imaging device, heat sensing camera, temperature sensor, among others), an amount of fuel available for motor component, an amount of charge stored in energy storage device, a signal from a controller of the welding operation, a signal from a controller associated with welding device 600, and the like.

For example, welding device 600 can include first circuit component 520 to convert voltage from power source 510 for use with control of a welding operation on a workpiece. For instance, a hardware link board can be used to convert and isolate voltage from power source 510 to use for the welding operation or control thereof. In such example, the hardware link board can step down voltage from power source 510 to 40 volts. In an example, converter component 530 can convert the 40 volts to a second voltage that is lower than 40 volts and use such second voltage with illumination system 525. In still another embodiment, the hardware link board can incorporate converter component 530 to provide the second voltage.

Illumination system 525 can include switch 610 that activates or deactivates lighting element 550. For instance, switch 610 can control electric flow (e.g., second voltage) between light power source 540 and lighting element 550. It is to be appreciated that the manner of how switch 610 activates or deactivates the second voltage to lighting element 550 can be chosen with sound engineering judgment without departing from the intended scope of coverage of the embodiments of the subject invention. By way of example and not limitation, switch 610 can be a button, a lever, a slider, a touchscreen, a touch-activated button, a toggle switch, a knob, a voice activated device, a motion sensor, a pressure sensor, and the like. In an embodiment, switch 610 can be a light sensor that detects an amount of brightness for an environment of welding device 500, wherein lighting element 550 illuminates based on the amount of brightness for the environment

Lighting element 540 can be incorporated into housing 620. Housing is configured to contain lighting element 540. For instance, housing 620 can be fabricated from any suitable material such as, but not limited to, a plastic, a steel, a metal, a polymer, a combination thereof, and the like.

Further, housing 620 can contain energy storage device 630. Energy storage device 630 can store a portion of the second voltage to allow for a portable use of lighting element 550. For instance, lighting element 550 can be electrically decoupled from welding device 600 and/or light power source 540, wherein a stored portion of the second voltage within energy storage device 630 is used to illuminate lighting element 550. It is to be appreciated that for the sake of brevity any components or circuitry that provides use of stored second voltage in energy storage device 630 are not illustrated but one of sound engineering judgment can chose circuitry and/or components to allow portability and decoupling use of lighting element 550.

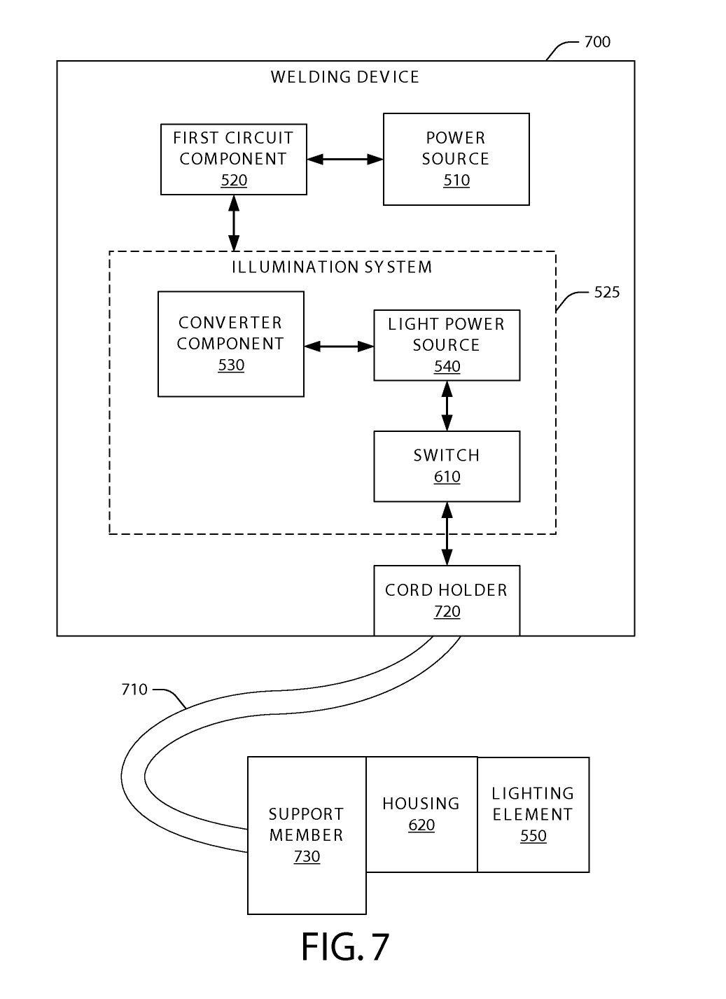

FIG. 7 illustrates welding device 700 that includes illumination system 525 for lighting up an environment. Lighting element 550 can use the second voltage provided by light power source 540 via converter 530 and/or first circuit component 520. In particular, cord 710 can provide electrical connectivity between lighting element 550 and at least one of switch 610 or light power source 540. It is to be appreciated that cord 710 can be any suitable material and can be flexible in construction to allow maneuverability for positioning of lighting element 550. Moreover, it is to be appreciated that cord 710 can provide electrical connectivity through at least one of support member 730 or housing 620 in order to provide the second voltage to lighting element 550.

Welding device 700 can further include cord holder 720 that can contain, house, or store a portion of cord 710. In a particular embodiment, cord holder 720 can include a spring-loaded or mechanical mechanism that allows for automatic winding or retraction of a portion of cord 710. Although cord 710 and cord holder 720 are depicted, it is to be appreciated and noted that a cordless embodiment is also included with the subject disclosure as discussed in FIG. 6 with use of an energy storage device. Further, cord holder 720 can be incorporated into welding device 700 (as depicted), a stand-alone holder, or a combination thereof.

Support member 730 can couple to housing 620 that contains lighting element 550. It is to be appreciated that support member 730 can couple directly to lighting element 550 if no housing 620 is utilized. In another embedment, housing 620 can be utilized as support member 730. Support member 730 provides a location for a user to handle, grip, hold, or position lighting element 550. For instance, support member 730 can be an ergonomic shape that conforms to a portion of a hand, a palm, a finger, and the like. In another embodiment, support member 730 can be shaped to affix to a mechanical device such as, but not limited to, a welding torch, a welding helmet, a welding visor, a clamp, among others. Support member 730 can further provide detachment from welding device 700 and in particular a housing of welding device 700. For instance, in either a corded or cordless use, support member 730 can be used to holster lighting element 540 to a portion of welding device 700 and also be used to holster on a stand for positioning of a desired location for illumination. In another embodiment, support member 730 can be interchangeably coupled to various locations on welding device 700 such as, but not limited to, a front of welding device 700, a side of welding device 700, a rear of welding device 700, a corner of welding device 700, a top of welding device 700, a bottom of welding device 700, among others.

In an embodiment, the lighting element is at least one of a bulb, a filament bulb, a Light Emitting Diode (LED), a fluorescent, a halogen, or a Compact Fluorescent Lamp (CFL). In an embodiment, the converter component isolates and conditions the second voltage converted from the first voltage. In an embodiment, the welding device can include a housing for containing the lighting element. In the embodiment, the welding device can include an energy storage device affixed to the housing for containing the lighting element, wherein the energy storage device stores a portion of the second voltage. In the embodiment, the welding device can include a support member coupled to the housing, wherein the support member is detachable from a housing of the welding device. In an embodiment, the support member is shaped to conform to a portion of a hand of a user.

In an embodiment, the welding device can include a housing of the welding device that includes an energy storage device to store a portion of the second voltage. In an embodiment, the welding device can include a cord that connects at least the lighting element to the light power source. In the embodiment, the welding device can include a cord holder that stores a portion of the cord. In an embodiment, the cord holder includes a switch that automatically retracts and winds a portion of the cord. In an embodiment, the welding device can include a light sensor that detects an amount of brightness for an environment of the welding device, wherein the lighting element illuminates based on the amount of brightness for the environment. In the embodiment, the welding device can include an energy storage device that is an additional power source for the welding device to perform the welding operation and a switch component that selects between the energy storage device and the motor. In an embodiment, the converter component converts a voltage stored in the energy storage device to the second voltage used to illuminate the lighting element.

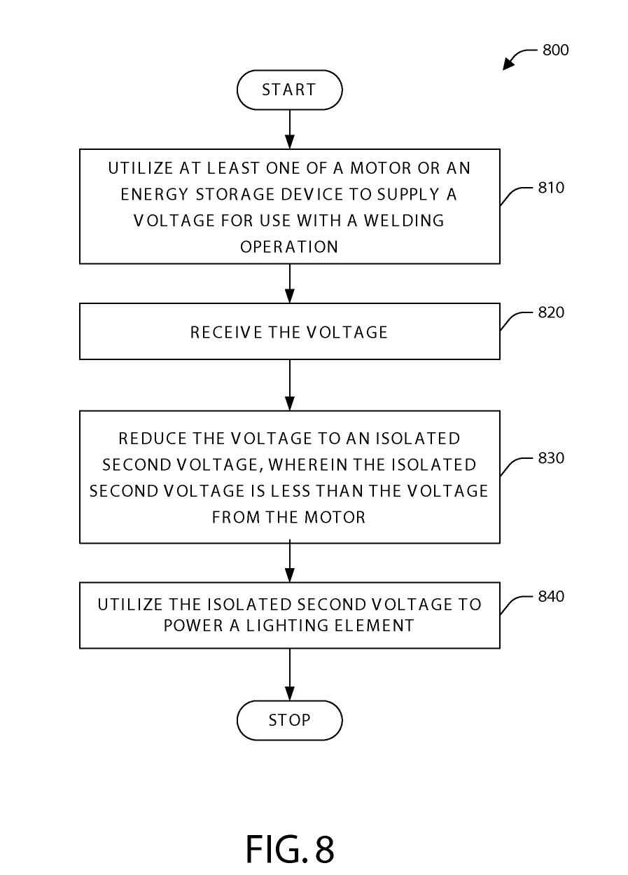

In view of the exemplary devices and elements described supra, methodologies that may be implemented in accordance with the disclosed subject matter will be better appreciated with reference to the flow charts and/or methodologies of FIG. 8. The methodologies and/or flow diagrams are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods and/or flow diagrams described hereinafter.

Sequentially, the following occurs as illustrated in the decision tree flow diagram 800 of FIG. 8 which is flow diagram 800 that converts a voltage from a power source associated with an engine driven welder for use a lighting element. At least one of a motor or an energy storage device is utilized to supply a voltage for use with a welding operation (reference block 810). The voltage can be received (reference block 820). The voltage is reduced to an isolated second voltage, wherein the isolated second voltage is less than the voltage of the motor (reference block 830). The isolated second voltage is utilized to power a lighting element (reference block 840).

In an embodiment of the method, the lighting element is at least one of a bulb, a filament bulb, a Light Emitting Diode (LED), a fluorescent, a halogen, or a Compact Fluorescent Lamp (CFL). In an embodiment, the method can include storing a portion of the second voltage in an lighting element energy storage device and using the portion of the second voltage in the lighting element energy storage device to illuminate the lighting element. In an embodiment, the method can include detected a brightness of an environment and activating the lighting element based on the detected brightness. In an embodiment, the method can include retracting a portion of a cord connected between the lighting element and the welding device based upon at least one of a mechanical switch.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welding device, comprising:
a motor-driven welder assembly including a motor that is a power source for the welder device to perform a welding operation;
a circuit component that electrically isolates and converts the power source to a first voltage used for controlling the welding operation;
a converter component that converts the first voltage to a second voltage; and
a lighting element that uses a portion of the second voltage as a light power source to illuminate the lighting element, wherein the lighting element illuminates based on a switch.

2. The welding device of claim 1, wherein the lighting element is at least one of a bulb, a filament bulb, a Light Emitting Diode (LED), a fluorescent, a halogen, or a Compact Fluorescent Lamp (CFL).

3. The welding device of claim 1, wherein the converter component isolates and conditions the second voltage converted from the first voltage.

4. The welding device of claim 1, further comprising a housing for containing the lighting element.

5. The welding device of claim 4, further comprising an energy storage device affixed to the housing for containing the lighting element, wherein the energy storage device stores a portion of the second voltage.

6. The welding device of claim 5, further comprising a support member coupled to the housing, wherein the support member is detachable from a housing of the welding device.

7. The welding device of claim 6, wherein the support member is shaped to conform to a portion of a hand of a user.

8. The welding device of claim 1, further comprising a housing of the welding device that includes an energy storage device to store a portion of the second voltage.

9. The welding device of claim 1, further comprising a cord that connects at least the lighting element to the light power source.

10. The welding device of claim 9, further comprising a cord holder that stores a portion of the cord.

11. The welding device of claim 10, wherein the cord holder includes a switch that automatically retracts and winds a portion of the cord.

12. The welding device of claim 1, further comprising a light sensor that detects an amount of brightness for an environment of the welding device, wherein the lighting element illuminates based on the amount of brightness for the environment.

13. The welding device of claim 1, further comprising:
an energy storage device that is an additional power source for the welding device to perform the welding operation; and
a switch component that selects between the energy storage device and the motor.

14. The welding device of claim 13, wherein the converter component converts a voltage stored in the energy storage device to the second voltage used to illuminate the lighting element.

15. A method for a welding device, comprising:
utilizing at least one of a motor or an energy storage device to supply a voltage for use with a welding operation;
receiving the voltage;
reducing the voltage to an isolated second voltage, wherein the isolated second voltage is less than the voltage from the motor; and
utilizing the isolated second voltage to power a lighting element.

16. The method of claim 15, wherein the lighting element is at least one of a bulb, a filament bulb, a Light Emitting Diode (LED), a fluorescent, a halogen, or a Compact Fluorescent Lamp (CFL).

17. The method of claim 15, further comprising:
storing a portion of the second voltage in an lighting element energy storage device; and
using the portion of the second voltage in the lighting element energy storage device to illuminate the lighting element.

18. The method of claim 17, further comprising:
detected a brightness of an environment; and
activating the lighting element based on the detected brightness.

19. The method of claim 15, further comprising retracting a portion of a cord connected between the lighting element and the welding device based upon at least one of a mechanical switch.

20. A welding device, comprising:
a motor-driven welder assembly including a motor that is a power source for the welder device to perform a welding operation;
a circuit component that electrically isolates and converts the power source to a first voltage used for controlling the welding operation;
a converter component that converts the first voltage to a second voltage;
a housing for containing the lighting element;
an energy storage device affixed to the housing, wherein the energy storage device stores a portion of the second voltage;
a support member coupled to the housing, wherein the support member is detachable from a housing of the welding device; and
means for emitting light using the portion of the second voltage as a primary power source.
